(19) United States
(12) Patent Application Publication
(10) Pub. No.: US 2021/0174611 A1
(43) Pub. Date: Jun. 10, 2021

(54) APPARATUS AND METHOD FOR GENERATING A MOTOR DIAGNOSIS MODEL

(71) Applicant: Institute For Information Industry, Taipei (TW)

(72) Inventors: Hsin-Tse LU, Taipei (TW); Veeresha Ramesha ITTANGIHALA, Taipei (TW); Chih-Hsuan LIANG, Taipei (TW); Xaver CHEN, Taipei (TW)

(21) Appl. No.: 16/798,326

(22) Filed: Feb. 22, 2020

(30) Foreign Application Priority Data
Dec. 4, 2019 (TW) 108144309

(51) Int. Cl. G07C 5/08; G06Q 50/04; G06N 20/00; G06N 5/04; B60K 1/02

(52) U.S. Cl. CPC G07C 5/0808; G06Q 50/04; B60K 1/02; G06N 5/04; G06N 20/00

(57) ABSTRACT

An apparatus and method for generating a motor diagnosis model. Each first dimension-reduced datum of a first motor corresponds to a normal state, an offline state, or an abnormal state, while each second dimension-reduced datum corresponds to the normal state or the offline state. The apparatus rotates the first dimension-reduced data or the second dimension-reduced data and integrates the rotated results with the dimension-reduced data that have not been rotated as a to-be-analyzed dataset. The apparatus trains a classification model for distinguishing data sources by using a subset of the to-be-analyzed dataset, derives an accuracy rate by testing the classification model for distinguishing data sources by using another subset of the to-be-analyzed dataset, and determines whether to use the to-be-analyzed dataset to generate the motor diagnosis model for the second motor.

### PRIORITY

This application claims priority to Taiwan Patent Application No. 108144309 filed on Dec. 4, 2019, which is hereby incorporated by reference in its entirety.

### FIELD

The present invention relates to an apparatus and method for generating a motor diagnosis model. In particular, the present invention relates to an apparatus and method for generating a motor diagnosis model for a motor without a complete operation record by using the feature data of a motor with a complete operation record.

### BACKGROUND

In order to manage a large number of motors that drive various equipment in an operating environment (e.g., a factory), a manufacturer needs to know various operation states of these motors. Currently, the common approach in the art is inspecting motors one by one manually. Nevertheless, this approach requires huge human resources and can only passively react to the detected abnormal state of a motor, which causes the loss of turning off the equipment.

To avoid the drawbacks of inspecting motors one by one manually, some manufacturers manage a large number of motors by one or more motor diagnosis models that are generated by the machine learning technology. In order to generate a motor diagnosis model by the machine learning technology, the feature data of the motor(s) working under various operation states (including various normal state, offline state, and abnormal state) must be collected, each of the feature data has to be labelled by the user, and then the motor diagnosis model can be derived by using the labeled feature data to train a neural network model. However, both labeling feature data and training a neural network model are time-consuming.

In addition, different motors of the same model have different physical properties, which may be in essence or may be caused by being equipped in different machines (e.g., being installed in different machines, being maintained by different persons). In order to achieve accurate diagnosis results, it is necessary to train an individual motor diagnosis model for each motor, but the incurred time costs will become unaffordable. Furthermore, a complete operation record of a motor is required (i.e., the feature data captured when the motor is under various states) for generating a motor diagnosis model for the motor, but feature data of the abnormal state of the motor cannot be collected when the motor is still operating normally. All the aforesaid problems have to be overcome.

Accordingly, a technique that can simply and efficiently generate a motor diagnosis model without using a complete operation record is still in an urgent need in this field.

### SUMMARY

The disclosure includes an apparatus for generating a motor diagnosis model. The apparatus in one example may comprise a storage and a processor, wherein the processor is electrically connected to the storage. The storage stores a plurality of first feature data of a first motor and a plurality of second feature data of a second motor. The processor generates a plurality of first dimension-reduced data corresponding to the first feature data, wherein each of the first dimension-reduced data corresponds to one of a normal state, an offline state, and an abnormal state. The processor further generates a plurality of second dimension-reduced data corresponding to the second feature data, wherein each of the second dimension-reduced data corresponds to one of the normal state and the offline state.

The processor further executes one of an operation (a) and an operation (b). The operation (a) rotates each of the first dimension-reduced data by a first angle to obtain a third dimension-reduced datum individually and uses the third dimension-reduced data and the second dimension-reduced data as a to-be-analyzed dataset. The operation (b) rotates each of the second dimension-reduced data by a second angle to obtain a fourth dimension-reduced datum individually and uses the fourth dimension-reduced data and the first dimension-reduced data as the to-be-analyzed dataset. The processor further trains a first classification model for distinguishing data sources according to a first subset of the to-be-analyzed dataset, the processor further derives a first accuracy rate by testing the first classification model for distinguishing data sources by using a second subset of the to-be-analyzed dataset, and the processor further determines whether to use the to-be-analyzed dataset to generate the motor diagnosis model for the second motor according to the first accuracy rate.

The disclosure also includes a method for generating a motor diagnosis model, which is adapted for use in an electronic computing apparatus. The electronic computing apparatus in one example stores a plurality of first feature data of a first motor and a plurality of second feature data of a second motor. The method comprising the steps (a) to (f). The step (a) generates a plurality of first dimension-reduced data corresponding to the first feature data, wherein each of the first dimension-reduced data corresponds to one of a normal state, an offline state, and an abnormal state. The step (b) generates a plurality of second dimension-reduced data corresponding to the second feature data, wherein each of the second dimension-reduced data corresponds to one of the normal state and the offline state.

The step (c) executes one of the following step (c1) and step (c2). The step (c1) rotates each of the first dimension-reduced data by a first angle to individually obtain a third dimension-reduced datum and uses the third dimension-reduced data and the second dimension-reduced data as a to-be-analyzed dataset. The step (c2) rotates each of the second dimension-reduced data by a second angle to individually obtain a fourth dimension-reduced datum and uses the fourth dimension-reduced data and the first dimension-reduced data as the to-be-analyzed dataset. The step (d) trains a first classification model for distinguishing data sources by using a first subset of the to-be-analyzed dataset. The step (e) derives a first accuracy rate by testing the first classification model for distinguishing data sources by using a second subset of the to-be-analyzed dataset. The step (f) determines whether to use the to-be-analyzed dataset to generate the motor diagnosis model for the second motor according to the first accuracy rate.

The technology for generating a motor diagnosis model (at least including the apparatus and the method) provided herein generates a plurality of first dimension-reduced data for a plurality of first feature data of a first motor with a complete operation record and generates a plurality of second dimension-reduced data for a plurality of second feature data of a second motor without a complete operation record. Since the first motor has a complete operation record, each of the first dimension-reduced data corresponds to a normal state, an offline state, or an abnormal state. Since the second motor does not have a complete operation record, each of the second dimension-reduced data corresponds to a normal state or an offline and no second dimension-reduced data corresponds to an abnormal state.

The technology provided herein further rotates the first dimension-reduced data or the second dimension-reduced data and then integrates the rotated results with the unrotated dimension-reduced data into a to-be-analyzed dataset. The technology provided herein further trains a classification model for distinguishing data sources according to a subset of the to-be-analyzed dataset, derives an accuracy rate by testing the classification model for distinguishing data sources by using another subset of the to-be-analyzed dataset, and determines whether to use the to-be-analyzed dataset to generate the motor diagnosis model for the second motor according to the first accuracy rate.

In particular, if the accuracy rate is lower than a threshold (i.e., the classification model cannot correctly distinguish data sources (either from the first motor or the second motor) of most of the dimension-reduced data), it means that the dimension-reduced data corresponding to the first motor and the dimension-reduced data corresponding to the second motor have been thoroughly mixed. Thus, the technology provided herein will generate the motor diagnosis model for the second motor according to the to-be-analyzed dataset. If the accuracy rate is higher than a threshold (i.e., the classification model can correctly distinguish data sources (either from the first motor or the second motor) of most of the dimension-reduced data), it means that the dimension-reduced data corresponding to the first motor and the dimension-reduced data corresponding to the second motor have not been thoroughly mixed. Thus, the technology provided herein will not generate the motor diagnosis model for the second motor according to the to-be-analyzed dataset. In the case of the accuracy rate being higher than the threshold, the technology provided herein further executes the foregoing operations/steps again to generate other to-be-analyzed dataset and then executes the subsequent training and determination.

Therefore, the technology for generating a motor diagnosis model provided herein can simply and efficiently generate a motor diagnosis model for a second motor that does not have a complete operation record. As a result, the manufacturers can automatically manage the operation statuses of a large number of motors.

The detailed technology and preferred embodiments are described in the following paragraphs accompanying the appended drawings for people skilled in this field to well appreciate the features of the claimed invention.

### BRIEF DESCRIPTION OF THE DRAWINGS

FIG. 1A is a schematic view depicting a model generation apparatus 1 according to a first embodiment of the present invention;

FIG. 1B illustrates a specific example of a first model ml and its distinguished region N1 (corresponding to a normal state), region 01 (corresponding to an offline state), and region A1 (corresponding to an abnormal state);

FIG. 1C illustrates a specific example of a second model m2 and its distinguished region N2 (corresponding to a normal state) and region O2 (corresponding to an offline state);

FIG. 1D illustrates a specific example of rotating the first dimension-reduced data; and

FIG. 2 is a flowchart depicting a model generation method of a second embodiment of the present invention.

### DETAILED DESCRIPTION

In the following description, an apparatus and a method for generating a motor diagnosis model according to the present invention will be explained with reference to certain example embodiments thereof. However, these example embodiments are not intended to limit the present invention to any environment, applications, examples, embodiments or implementations described in these example embodiments. Therefore, description of these example embodiments is only for purpose of illustration rather than to limit the scope of the present invention.

It shall be appreciated that, in the following embodiments and the attached drawings, elements unrelated to the present invention are omitted from depiction; and dimensions of and dimensional relationships between individual elements in the attached drawings are provided only for illustration, but not to limit the scope of the present invention.

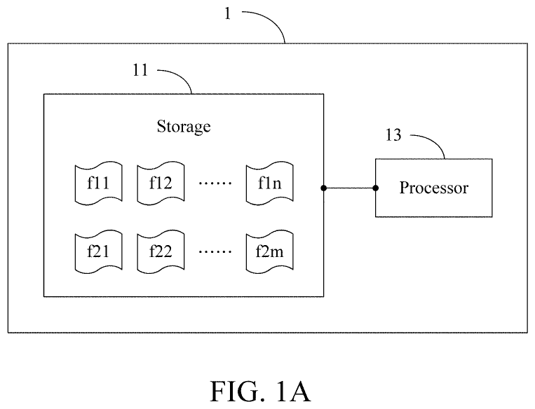

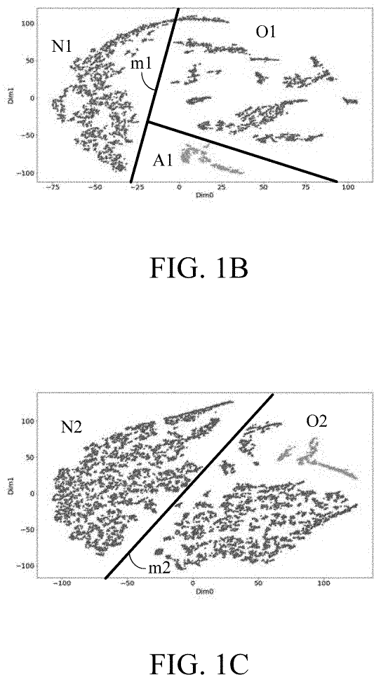

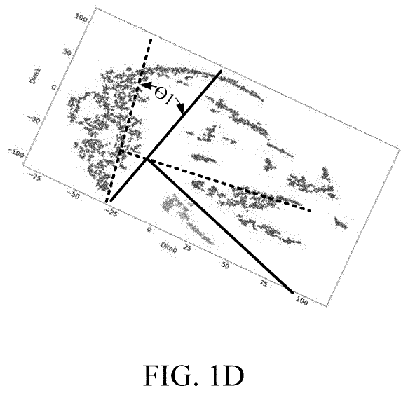

A first embodiment of the present invention is an apparatus for generating a motor diagnosis model (hereinafter referred to as “model generation apparatus 1”), whose schematic view is depicted in FIG. 1A. The model generation apparatus 1 comprises a storage 11 and a processor 13, wherein the storage 11 is electrically connected with the processor 13. The storage 11 may be one of a memory, a hard disk drive (HDD), a universal serial bus (USB), a compact disk (CD), or any other storage media or circuits with the same function and well-known to those of ordinary skill in the art. The processor 13 may be one of various processors, central processing units (CPUs), microprocessor units (MPUs), digital signal processors (DSPs), or any other computing apparatus with the same function and well-known to those of ordinary skill in the art.

In order to generate a motor diagnosis model for a motor, a complete operation record of that motor is required (i.e., the feature data captured when the motor is under various normal states, offline state, and abnormal state). However, the feature data corresponding to the abnormal state of the motor can only be obtained when the motor is operating abnormally, and generating a motor diagnosis model for the motor after the motor has operated abnormally is of no help. To solve the aforesaid problem, the model generation apparatus 1 generates a motor diagnosis model for a motor that does not have a complete operation record according to feature data of a motor that has a complete operation record. Hereinafter, the operations performed by the model generation apparatus 1 will be described in details.

In this embodiment, a first motor (not shown) has a complete operation record and a second motor (not shown) does not have a complete operation record, wherein the first motor and the second motor are of the same brand and of the same model. The storage 11 of the model generation apparatus 1 stores a plurality of first feature data f11, f12, . . . , f1n of the first motor, wherein each of the first feature data f11, f12, . . . , f1n corresponds to one of a normal state (not shown), an offline state (not shown), and an abnormal state (not shown). The storage 11 also stores a plurality of second feature data f21, f22, . . . , f2m of the second motor, wherein each of the second feature data f21, f22, . . . , f2m corresponds to one of a normal state (not shown) and an offline state (not shown). It shall be appreciated that the types of the feature data of the first motor and the second motor stored in the storage 11 are not limited in the present invention. For example, a feature data of a motor may comprise temperature, vibration, rotation speed, acceleration, voltage, and/or electric current of the motor, but not limited thereto.

In order to increase the subsequent processing efficiency, the processor 13 of the model generation apparatus 1 generates a plurality of first dimension-reduced data corresponding to the first feature data f11, f12, . . . , f1n (i.e., reduce the dimension of each of the first feature data f11, f12, . . . , f1n) and generates a plurality of second dimension-reduced data corresponding to the second feature data f21, f22, . . . , f2m (i.e., reduce the dimension of each of the second feature data f21, f22, . . . , f2m). For comprehension, please refer to a specific example shown in FIG. 1B and FIG. 1C. This specific example will be used in the subsequent description. It is noted that descriptions related to this specific example is not intended to limit the scope of the present invention. FIG. 1B depicts the first dimension-reduced data derived by reducing the first feature data f11, f12, . . . , f1n to two-dimension, where each dot represents a piece of first dimension-reduced data. FIG. 1C depicts the second dimension-reduced data derived by reducing the second feature data f21, f22, . . . , f2m to two-dimension, where each dot represents a piece of second dimension-reduced data.

In this embodiment, the processor 13 of the model generation apparatus 1 generates the first dimension-reduced data and the second dimension-reduced data by a dimension reduction algorithm. For example, the dimension reduction algorithm may be one of a

Principal Components Analysis (PCA) algorithm, a Linear Discriminant Analysis (LDA) algorithm, and a t-Distributed Stochastic Neighbor Embedding (t-SNE) algorithm, but it is not limited thereto. It shall be appreciated that how to use the dimension reduction algorithm to reduce the feature data shall be well-known by those of ordinary skill in the art, so the details are not given herein.

In this embodiment, the processor 13 generates a first model ml according to the first dimension-reduced data, wherein the first model ml distinguish the first dimension-reduced data into a normal state, an offline state, and an abnormal state. Please note that since each of the first feature data f11, f12, . . . , f1n corresponds to one of the normal state, the offline state, and the abnormal state, each of the first dimension-reduced data also corresponds to one of the normal state, the offline state, and the abnormal state and, thus, the processor 13 can generate the first model m1 accordingly. Please refer to the specific example shown in FIG. 1B. The first dimension-reduced data lies in the region N1 corresponds to the normal state, the first dimension-reduced data lies in the region O1 corresponds to the offline state, and the first dimension-reduced data lies in the region A1 corresponds to the abnormal state.

The processor 13 generates a second model m2 according to the second dimension-reduced data, wherein the second model m2 distinguish the second dimension-reduced data into a normal state and an offline state. Similarly, since each of the second feature data f21, f22, . . . , f2m corresponds to one of the normal state and the offline state, each of the second dimension-reduced data also corresponds to one of the normal state and the offline state and, thus, the processor 13 can generate the second model m2 accordingly. Please refer to the specific example shown in FIG. 1C. The second dimension-reduced data lies in the region N2 corresponds to the normal state, and the second dimension-reduced data lies in the region O2 corresponds to the offline state.

In this embodiment, the processor 13 rotates each of the first dimension-reduced data by a first angle θ1 to obtain a third dimension-reduced datum individually. For example, the processor 13 may refer to the first model m1 and the second model m2 to determine the first angle θ1. Please refer to FIG. 1D, which illustrates a specific example of rotating the first dimension-reduced data. Please note that the specific example shown in FIG. 1D is not intended to limit the scope of the present invention. It shall be appreciated that each of the first model m1 and the second model m2 can be represented by at least one mathematical equation, therefore the processor 13 may determine the angle that the first dimension-reduced data has to be rotated according to the first model m1 and the second model m2 in order to make the regions corresponding to the normal state and the offline state of the third dimension-reduced data be approximately the same as the region N2 and the region O2 respectively. For example, the degree of overlap between the region corresponding to the normal state of the third dimension-reduced data and the region N2 must be higher than a preset ratio, and the degree of overlap between the region corresponding to the offline state of the third dimension-reduced data must be higher than the preset ratio.

Next, the processor 13 integrates the third dimension-reduced data obtained after the rotation and the second dimension-reduced data that has not been rotated into a first to-be-analyzed dataset (not shown). That is, the first to-be-analyzed dataset comprises a plurality of dimension-reduced data, and each of the dimension-reduced data in the first to-be-analyzed dataset is one of the third dimension-reduced data and the second dimension-reduced data. Since each of the dimension-reduced data in the first to-be-analyzed dataset is one of the third dimension-reduced data and the second dimension-reduced data, each of the dimension-reduced data in the first to-be-analyzed dataset corresponds to one of the first motor and the second motor.

The processor 13 determines a first subset (not shown) from the first to-be-analyzed dataset and trains a first classification model (not shown) for distinguishing data sources according to the dimension-reduced data comprised in the first subset. That is, the first classification model is used to identify each of the dimension-reduced data coming from the first motor or the second motor. For example, the first classification model may be a Support Vector Machine (SVM) or a Bayes classifier, but it is not limited thereto.

Furthermore, the processor 13 determines a second subset (not shown) from the first to-be-analyzed dataset, wherein the second subset is different from the first subset. In some embodiments, the first subset and second subset are mutually exclusive (i.e., they are disjoint). The processor 13 further derives a first accuracy rate by testing the first classification model for distinguishing data sources according to the second subset. In other words, the processor 13 tests the first classification model by the dimension-reduced data in the second subset to see if the first classification model can accurately determine the data source (i.e. either the first motor or the second motor) of each of them. Thereafter, the processor 13 determines whether to use the first to-be-analyzed dataset to generate the motor diagnosis model for the second motor according to the first accuracy rate.

Specifically, if the first accuracy rate is lower than a threshold (i.e., the first classification model cannot correctly distinguish data sources (either corresponding to the first motor or the second motor) of most of the dimension-reduced data, it means that the dimension-reduced data corresponding to the first motor and the dimension-reduced data corresponding to the second motor have been thoroughly mixed. Thus, the processor 13 decides to generate the motor diagnosis model for the second motor according to the first to-be-analyzed dataset. For example, the processor may use the first to-be-analyzed dataset to train a Convolutional Neural Network (CNN) as the motor diagnosis model of the second motor. For another example, the processor may use the first to-be-analyzed dataset and K-means clustering algorithm to generate the motor diagnosis model for the second motor.

If the first accuracy rate is higher than a threshold (i.e., the first classification model can correctly distinguish data sources (either from the first motor or the second motor) of most of the dimension-reduced data), it means that the dimension-reduced data corresponding to the first motor and the dimension-reduced data corresponding to the second motor have not been thoroughly mixed. Thus, the processor 13 will not generate the motor diagnosis model for the second motor according to the first to-be-analyzed dataset. If the first accuracy rate is higher than a threshold, the processor 13 further rotates each of the first dimension-reduced data by another angle (this is different from the first angle) to obtain a dimension-reduced datum individually and integrates the dimension-reduced data obtained after the rotation this time and the second dimension-reduced data that has not been rotated into a second to-be-analyzed dataset. Then, the processor 13 trains a second classification model for distinguishing data sources according to a third subset of the second to-be-analyzed dataset, derives a second accuracy rate by testing the second classification model for distinguishing data sources according to a fourth subset of the second to-be-analyzed dataset, and determines whether to use the second to-be-analyzed dataset to generate the motor diagnosis model for the second motor according to the second accuracy rate.

Based on the aforesaid descriptions, those of ordinary skill in the art shall appreciate that the processor 13 may repeats the aforesaid operations until finding out a to-be-analyzed dataset that can be used for training the motor diagnosis model for the second motor. Thus, the details will not be repeated herein.

As described above, in this embodiment, the processor 13 rotates the first dimension-reduced data corresponding to the first motor and then executes the subsequent related operations. Please note that, in other embodiments, the processor 13 may rotate the second dimension-reduced data corresponding to the second motor instead. How the processor 13 rotates the second dimension-reduced data corresponding to the second motor and how the processor 13 executes the subsequent related operations to find out a to-be-analyzed dataset that can be used for training the motor diagnosis model for the second motor shall be appreciated by those of ordinary skill in the art. Hence, the details will not be repeated herein.

According to the above descriptions, the model generation apparatus 1 generates a plurality of first dimension-reduced data f11, f12, . . . , f1n for a plurality of first feature data of a first motor which has a complete operation record and generates a plurality of second dimension-reduced data f21, f22, . . . , f2m for a plurality of second feature data of a second motor which does not have a complete operation record. Since the first motor has a complete operation record, the first model m1 generated by the model generation apparatus 1 can distinguish the first dimension-reduced data into a normal state, an offline state, and an abnormal state. Since the second motor does not have a complete operation record, the second model m2 generated by the model generation apparatus 1 can only distinguish the second dimension-reduced data into a normal state and offline state.

The model generation apparatus 1 further rotates the first dimension-reduced data or the second dimension-reduced data and then integrates the rotated results with the unrotated dimension-reduced data into a to-be-analyzed dataset. The model generation apparatus 1 further trains a classification model for distinguishing data sources according to a subset of the to-be-analyzed dataset, derives an accuracy rate by testing the classification model for distinguishing data sources by using another subset of the to-be-analyzed dataset, and determines whether to use the to-be-analyzed dataset to generate the motor diagnosis model for the second motor according to the first accuracy rate.

If the accuracy rate is lower than a threshold, the model generation apparatus 1 generates the motor diagnosis model for the second motor according to the to-be-analyzed dataset. If the accuracy rate is higher than the threshold, the model generation apparatus 1 will not generate the motor diagnosis model for the second motor according to the to-be-analyzed dataset. Instead, the model generation apparatus 1 rotates the dimension-reduced data again to find another to-be-analyzed dataset and then executes the subsequent training and determination. According to the foregoing operation, the model generation apparatus 1 can simply and efficiently generate a motor diagnosis model for a second motor that does not have a complete operation record. As a result, the manufacturers can automatically manage the operation statuses of a large number of motors easily.

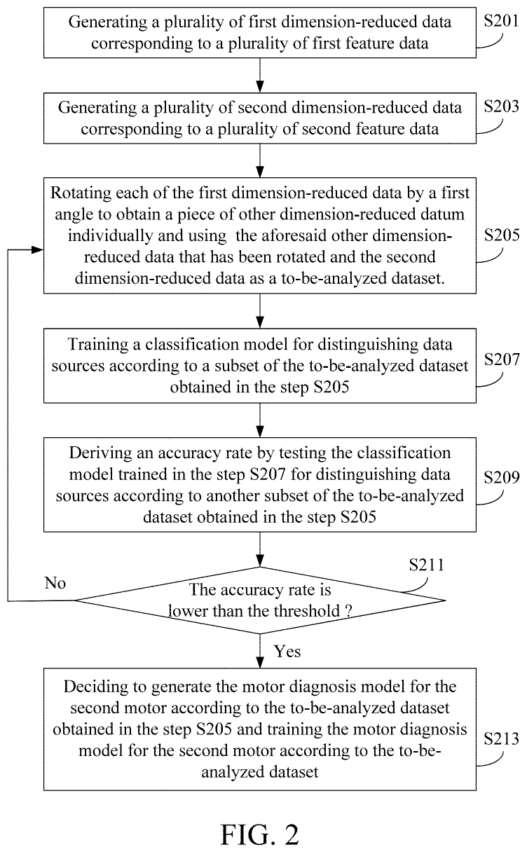

A second embodiment of the present invention is a method for generating a motor diagnosis model (hereinafter referred to as “model generation method”) and a flowchart of which is depicted in FIG. 2. The model generation method is suitable for use in an electronic apparatus (e.g., the model generation apparatus 1 described in the first embodiment).

In this embodiment, the electronic apparatus stores a plurality of first feature data of a first motor and a plurality of second feature data of a second motor, each of the first dimension-reduced data corresponds to one of a normal state, an offline state, and an abnormal state, and each of the second dimension-reduced data corresponds to one of the normal state and the offline state. The model generation method comprises the steps S201 to S213.

Specifically, in the step S201, the electronic computing apparatus generates a plurality of first dimension-reduced data corresponding to the first feature data. It is noted that each of the first feature data corresponds to one of a normal state, the offline state, and the abnormal state, thus each of the first dimension-reduced data corresponds to one of the normal state, the offline state, and the abnormal state as well, and the model generation method can generate a first model for distinguishing the first dimension-reduced data being in the normal state, the offline state, and the abnormal state accordingly.

In the step S203, the electronic computing apparatus generates a plurality of second dimension-reduced data corresponding to the second feature data. Please noted that each of the second feature data corresponds to one of a normal state and an offline state, thus each of the second dimension-reduced data corresponds to one of the normal state and the offline state as well, and the model generation method can generate a second model for distinguishing the second dimension-reduced data being in the normal state and the offline state accordingly.

It is noted that the present invention does not limit the execution order of the foregoing steps S201 and S203. In other words, the step S201 may be executed earlier than the step S203, the step S201 may be executed later than the steps S203, or the steps S201 and S203 may be executed simultaneously. In addition, in some embodiments, the steps S201 and S203 may respectively generate the first dimension-reduced data and the second dimension-reduced data by a dimension reduction algorithm. For example, the dimension reduction algorithm may be one of a PCA algorithm, an LDA algorithm, and a t-SNE algorithm, but it is not limited thereto.

In this embodiment, in the step S205, the electronic computing apparatus rotates each of the first dimension-reduced data by a first angle to obtain a piece of other dimension-reduced datum individually and uses the aforesaid other dimension-reduced data that has been rotated and the second dimension-reduced data as a to-be-analyzed dataset. In the step S207, the electronic computing apparatus trains a classification model for distinguishing data sources according to a subset of the to-be-analyzed dataset obtained in the step S205. In the step S209, the electronic computing apparatus derives an accuracy rate by testing the classification model trained in the step S207 for distinguishing data sources according to another subset of the to-be-analyzed dataset obtained in the step S205.

In the step S211, the electronic computing apparatus determines whether the accuracy rate is lower than a threshold. If it is determined in the step S211 that the accuracy rate is lower than the threshold, the model generation method executes the step S213. In the step S213, the electronic computing apparatus decides to generate the motor diagnosis model for the second motor according to the to-be-analyzed dataset obtained in the step S205, and train the motor diagnosis model for the second motor according to the to-be-analyzed dataset.

If it is determined in step S211 that the accuracy rate is not lower than the threshold, the model generation method may execute the step S205 again to rotate each of the first dimension-reduced data by an angle that has not been rotated to obtain a plurality of other dimension-reduced data and then repeat the steps S207, S209, and S211 until finding out a to-be-analyzed dataset for training the motor diagnosis model for the second motor. Thereafter, the model generation method trains the motor diagnosis model for the second motor according to the to-be-analyzed dataset.

As described, in this embodiment, the model generation method rotates the first dimension-reduced data corresponding to the first motor and then executes the subsequent related operations. Please not that, in other embodiments, the model generation method may rotate the second dimension-reduced data corresponding to the second motor instead instead. How the model generation method rotates the second dimension-reduced data corresponding to the second motor and then executes the subsequent related operations to find out a to-be-analyzed dataset that can be used for training the motor diagnosis model for the second motor shall be appreciated by those of ordinary skill in the art. Thus, the details will not be repeated herein.

In addition to the aforesaid steps, the second embodiment can also execute all the operations and steps of the model generation apparatus 1 set forth in the first embodiment, have the same functions, and deliver the same technical effects as the first embodiment. How the second embodiment executes these operations and steps, have the same functions, and deliver the same technical effects as the first embodiment shall be readily appreciated by those of ordinary skill in the art based on the explanation of the first embodiment, so the details are not given herein.

It is noted that in the specification and claims of this application, some terms (including motor, feature data, dimension-reduced data, model, angle, to-be-analyzed dataset, subset, classification model, and accuracy rate, etc.) are preceded by ordinal numerals “first,” “second,” “third,” “fourth,” “fifth,” or “sixth” and these ordinal numerals are only used to distinguish that these terms refer to different items.

According to the above descriptions, the technology for generating a motor diagnosis model (at least including the apparatus and the method) provided by the present invention generates a plurality of first dimension-reduced data for a plurality of first feature data of a first motor that has a complete operation record and generates a plurality of second dimension-reduced data for a plurality of second feature data of a second motor that does not have a complete operation record. Since the first motor has a complete operation record, each of the first dimension-reduced data corresponds to a normal state, an offline state, or an abnormal state. Since the second motor does not have a complete operation record, each of the second dimension-reduced data corresponds to a normal state or an offline, and no second dimension-reduced data corresponds to an abnormal state.

The technology provided by the present invention further rotates the first dimension-reduced data or the second dimension-reduced data and then integrates the rotated results with the unrotated dimension-reduced data into a to-be-analyzed dataset. The technology provided by the present invention further trains a classification model for distinguishing data sources according to a subset of the to-be-analyzed dataset, derives an accuracy rate by testing the classification model for distinguishing data sources by using another subset of the to-be-analyzed dataset, and determines whether to use the to-be-analyzed dataset to generate the motor diagnosis model for the second motor according to the first accuracy rate.

In particular, if the accuracy rate is lower than a threshold (i.e., the classification model cannot correctly distinguish data sources (either from the first motor or the second motor) of most of the dimension-reduced data), the dimension-reduced data corresponding to the first motor and the dimension-reduced data corresponding to the second motor have been thoroughly mixed. Thus, the technology provided by the present invention generates the motor diagnosis model for the second motor according to the to-be-analyzed dataset. If the accuracy rate is higher than a threshold (i.e., the classification model can correctly distinguish data sources (either from the first motor or the second motor) of most of the dimension-reduced data), the dimension-reduced data corresponding to the first motor and the dimension-reduced data corresponding to the second motor have not been thoroughly mixed. Thus, the technology provided by the present invention will not generate the motor diagnosis model for the second motor according to the to-be-analyzed dataset. In the case of the accuracy rate being higher than the threshold, the technology provided by the present invention further executes the foregoing operations again to generate another to-be-analyzed dataset and then executes the subsequent training and determination.

Therefore, the technology for generating a motor diagnosis model provided by the present invention can simply and efficiently generate a motor diagnosis model for a second motor that does not have a complete operation record. As a result, the manufacturers automatically manage the operation statuses of a large number of motors.

The above disclosure is only utilized to enumerate some embodiments of the present invention and illustrated technical features thereof, which is not used to limit the scope of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for generating a motor diagnosis model, comprising:
a storage, being configured to store a plurality of first feature data of a first motor and a plurality of second feature data of a second motor; and
a processor, being electrically connected to the storage and configured to generate a plurality of first dimension-reduced data corresponding to the first feature data and generate a plurality of second dimension-reduced data corresponding to the second feature data, wherein each of the first dimension-reduced data corresponds to one of a normal state, an offline state, and an abnormal state, and each of the second dimension-reduced data corresponds to one of the normal state and the offline state,
wherein the processor further executes one of an operation (a) and an operation (b),
wherein the operation (a) rotates each of the first dimension-reduced data by a first angle to obtain a third dimension-reduced datum individually and uses the third dimension-reduced data and the second dimension-reduced data as a first to-be-analyzed dataset,
wherein the operation (b) rotates each of the second dimension-reduced data by a second angle to obtain a fourth dimension-reduced datum individually and uses the fourth dimension-reduced data and the first dimension-reduced data as the first to-be-analyzed dataset,
wherein the processor further trains a first classification model for distinguishing data sources according to a first subset of the first to-be-analyzed dataset, the processor further derives a first accuracy rate by testing the first classification model for distinguishing the data sources according to a second subset of the first to-be-analyzed dataset, and the processor further determines whether to use the first to-be-analyzed dataset to generate the motor diagnosis model for the second motor according to the first accuracy rate.

2. The apparatus of claim 1, wherein a first model distinguishes the first dimension-reduced data into the normal state, the offline state, and the abnormal state, a second model distinguishes the second dimension-reduced data into the normal state and the offline state, and the processor determines the first angle according to the first model and the second model.

3. The apparatus of claim 1, wherein a first model distinguishes the first dimension-reduced data into the normal state, the offline state, and the abnormal state, a second model distinguishes the second dimension-reduced data into the normal state and the offline state, and the processor determines the second angle according to the first model and the second model.

4. The apparatus of claim 1, wherein when the first accuracy rate is lower than a threshold, the processor determines to generate the motor diagnosis model for the second motor according to the first to-be-analyzed dataset.

5. The apparatus of claim 1, wherein the processor executes the operation (a), when the first accuracy rate is higher than a threshold, the processor further rotates each of the first dimension-reduced data by a third angle to obtain a fifth dimension-reduced datum individually and uses the fifth dimension-reduced data and the second dimension-reduced data as a second to-be-analyzed dataset, wherein the third angle is different from the first angle,
wherein the processor further trains a second classification model for distinguishing the data sources according to a third subset of the second to-be-analyzed dataset, the processor further derives a second accuracy rate by testing the second classification model for distinguishing the data sources according to a fourth subset of the second to-be-analyzed dataset, and the processor further determines whether to use the second to-be-analyzed dataset to generate the motor diagnosis model for the second motor according to the second accuracy rate.

6. The apparatus of claim 1, wherein the processor executes the operation (b), when the first accuracy rate is higher than a threshold, the processor further rotates each of the second dimension-reduced data by a fourth angle to obtain a sixth dimension-reduced datum individually and uses the sixth dimension-reduced data and the first dimension-reduced data as a second to-be-analyzed dataset, wherein the fourth angle is different from the second angle,
wherein the processor further trains a second classification model for distinguishing the data sources according to a third subset of the second to-be-analyzed dataset, the processor further derives a second accuracy rate by testing the second classification model for distinguishing the data sources according to a fourth subset of the second to-be-analyzed dataset, and the processor further determines whether to use the second to-be-analyzed dataset to generate the motor diagnosis model for the second motor according to the second accuracy rate.

7. The apparatus of claim 1, wherein the processor generates the first dimension-reduced data and the second dimension-reduced data by a dimension reduction algorithm, and the dimension reduction algorithm is one of a Principal Components Analysis (PCA) algorithm, a Linear Discriminant Analysis (LDA) algorithm, and a t-Distributed Stochastic Neighbor Embedding (t-SNE) algorithm.

8. A method for generating a motor diagnosis model, being adapted for use in an electronic computing apparatus, the electronic computing apparatus storing a plurality of first feature data of a first motor and a plurality of second feature data of a second motor, the method comprising:
(a) generating a plurality of first dimension-reduced data corresponding to the first feature data, wherein each of the first dimension-reduced data corresponds to one of a normal state, an offline state, and an abnormal state;
(b) generating a plurality of second dimension-reduced data corresponding to the second feature data, wherein each of the second dimension-reduced data corresponds to one of the normal state and the offline state;
(c) executing one of the following step (c1) and step (c2):
(c1) rotating each of the first dimension-reduced data by a first angle to individually obtain a third dimension-reduced datum and using the third dimension-reduced data and the second dimension-reduced data as a first to-be-analyzed dataset; and
(c2) rotating each of the second dimension-reduced data by a second angle to individually obtain a fourth dimension-reduced datum and using the fourth dimension-reduced data and the first dimension-reduced data as the first to-be-analyzed dataset;
(d) training a first classification model for distinguishing data sources by using a first subset of the first to-be-analyzed dataset;
(e) deriving a first accuracy rate by testing the first classification model for distinguishing the data sources according to a second subset of the first to-be-analyzed dataset; and
(f) determining whether to use the first to-be-analyzed dataset to generate the motor diagnosis model for the second motor according to the first accuracy rate.

9. The method of claim 8, wherein a first model distinguishes the first dimension-reduced data into the normal state, the offline state, and the abnormal state, a second model distinguishes the second dimension-reduced data into the normal state and the offline state, and the step (c1) determines the first angle according to the first model and the second model.

10. The method of claim 8, wherein a first model distinguishes the first dimension-reduced data into the normal state, the offline state, and the abnormal state, a second model distinguishes the second dimension-reduced data into the normal state and the offline state, and the step (c2) determines the second angle according to the first model and the second model.

11. The method of claim 8, wherein when the first accuracy rate is lower than a threshold, the step (f) determines to generate the motor diagnosis model for the second motor according to the first to-be-analyzed dataset.

12. The method of claim 8, wherein the method executes the step (c1), when the first accuracy rate is higher than a threshold, the method further comprising:
rotating each of the first dimension-reduced data by a third angle to obtain a fifth dimension-reduced datum individually and uses the fifth dimension-reduced data and the second dimension-reduced data as a second to-be-analyzed dataset, wherein the third angle is different from the first angle;
training a second classification model for distinguishing the data sources according to a third subset of the second to-be-analyzed dataset;
deriving a second accuracy rate by testing the second classification model for distinguishing the data sources according to a fourth subset of the second to-be-analyzed dataset; and
determining whether to use the second to-be-analyzed dataset to generate the motor diagnosis model for the second motor according to the second accuracy rate.

13. The method of claim 8, wherein the method executes the step (c2), when the first accuracy rate is higher than a threshold, the method further comprising:
rotating each of the second dimension-reduced data by a fourth angle to obtain a sixth dimension-reduced datum individually and uses the sixth dimension-reduced data and the first dimension-reduced data as a second to-be-analyzed dataset, wherein the fourth angle is different from the second angle;
training a second classification model for distinguishing the data sources according to a third subset of the second to-be-analyzed dataset;
deriving a second accuracy rate by testing the second classification model for distinguishing the data sources according to a fourth subset of the second to-be-analyzed dataset; and
determining whether to use the second to-be-analyzed dataset to generate the motor diagnosis model for the second motor according to the second accuracy rate.

14. The method of claim 8, wherein the step (a) generates the first dimension-reduced data and the second dimension-reduced data by a dimension reduction algorithm, and the dimension reduction algorithm is one of a PCA algorithm, an LDA algorithm, and a t-SNE algorithm.
